(19) United States
(12) Patent Application Publication
(10) Pub. No.: US 2012/0320216 A1
(43) Pub. Date: Dec. 20, 2012

(54) Method and System for Object Recognition, Authentication, and Tracking with Infrared Distortion Caused by Objects for Augmented Reality

(75) Inventors: Armen Mkrtchyan, Glendale, CA (US); Christopher W. Heatherly, Monrovia, CA (US)

(73) Assignee: DISNEY ENTERPRISES, INC., BURBANK, CA (US)

(21) Appl. No.: 13/160,330

(22) Filed: Jun. 14, 2011

(51) Int. Cl. H04N 5/33

(52) U.S. Cl. 348/164; 348/E05.09

(57) ABSTRACT

There are presented methods and systems for virtual environment manipulation by detection of physical objects. An example method includes projecting an infrared pattern onto a physical environment having a physical object, capturing an infrared image of the physical environment using an infrared camera, detecting, in the infrared image, an infrared distortion caused by at least a portion of the physical object, the at least portion of the physical object comprising patterned materials affecting an infrared light, modifying a virtual environment based on the infrared distortion caused by the patterned materials affecting the infrared light, and rendering the modified virtual environment on a display. For example, the at least portion of the physical object is a tag placed on the physical object.

### BACKGROUND OF THE INVENTION

1. Field of the Invention

The present invention relates generally to object tracking. More particularly, the present invention relates to object recognition, authentication, and tracking using infrared distortion caused by objects.

2. Background Art

Object recognition, authentication, and tracking systems are used in a wide range of novel and exciting applications. The explosive popularity of motion-controlled video games, for example, demonstrates one particularly successful application of motion tracking. In addition to the video games industry, motion control can also be gainfully utilized in various other fields including telecommunications, entertainment, medicine, accessibility, and more.

In particular, the concept of “augmented reality” is gaining momentum, wherein virtual objects or overlays are presented on top of real world objects and vice versa. Hardware such as cameras, high-resolution displays, and three-dimensional graphics accelerators are already present in many devices, enabling various augmented reality applications on low cost commodity hardware.

For example, instead of referring to a dense and confusing instruction manual for technical support, a person might instead use an augmented reality application installed on a smart phone. The augmented reality application might, for example, assist a person in replacing a printer toner cartridge by speaking instructions and overlaying visual indicators on the display of the smart phone, which may show a camera feed of the printer. For example, the printer door mechanism and the empty toner cartridge might be outlined with a colorful flashing virtual overlay including simple written directions or diagrams. Verbal cues may also be spoken through speakers of the smart phone. In this manner, the user can follow friendly visual and audio cues for quick and easy toner replacement, rather than struggling with an obtuse instruction manual.

In another example, augmented reality can be applied to video game systems to provide new and exciting game play. For example, the camera of a portable video game system may be configured to detect special augmented reality cards with identifiable patterns, and a virtual environment may be shown to the user on a display where virtual objects, such as virtual avatars, appear to spring forth from the augmented reality cards in a real world environment captured by the camera.

While augmented reality opens up many exciting possibilities as discussed above, existing object recognition, authentication, and tracking systems have several drawbacks that preclude more advanced use case scenarios. For example, many systems use low-resolution cameras with limited fields of view, severely restricting the detectable range of objects. Tracking inaccuracies may also occur when tracked objects overlap or become obscured from the camera view. Furthermore, objects that tend to blend into the background or appear like other objects may be difficult to track accurately, such as similarly colored objects or identical objects. Accordingly, it may be difficult to implement augmented reality systems where objects are moving, where objects are partially obscured, or where the camera is moving.

Accordingly, there is a need to overcome the drawbacks and deficiencies in the art by providing more accurate object recognition, authentication, and tracking for augmented reality applications.

### SUMMARY OF THE INVENTION

There are provided systems and methods for object recognition, authentication, and tracking with infrared distortion caused by objects for augmented reality, substantially as shown in and/or described in connection with at least one of the figures, as set forth more completely in the claims. As an example, in one aspect, there are presented methods and systems for virtual environment manipulation by detection of physical objects. An example method includes projecting an infrared pattern onto a physical environment having a physical object, capturing an infrared image of the physical environment using an infrared camera, detecting, in the infrared image, an infrared distortion caused by at least a portion of the physical object, the at least portion of the physical object comprising patterned materials affecting an infrared light, modifying a virtual environment based on the infrared distortion caused by the patterned materials affecting the infrared light, and rendering the modified virtual environment on a display. For example, the at least portion of the physical object is a tag placed on the physical object.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1a presents a diagram of a system for tracking an object with an infrared distortion tag, according to one embodiment of the invention;

FIG. 1b presents a diagram of a system for tracking an object with an infrared distortion tag to present virtual objects in an augmented reality environment, according to one embodiment of the present invention;

FIG. 1c presents a diagram of a system for tracking an object with an infrared distortion tag to present virtual costumes in an augmented reality environment, according to one embodiment of the present invention;

FIG. 1d presents a diagram of a system for recognizing an object with an infrared distortion tag to unlock special features of an augmented reality videogame, according to one embodiment of the present invention;

FIG. 1e presents a diagram of a system for authenticating an object with an infrared distortion tag to unlock a custom avatar of an augmented reality videogame, according to one embodiment of the present invention; and

FIG. 2 shows a flowchart describing the steps, according to one embodiment of the present invention, by which an object may be recognized, authenticated, and tracked with an infrared distortion tag for augmented reality.

### DETAILED DESCRIPTION OF THE INVENTION

The present application is directed to a method and system for object recognition, authentication, and tracking with infrared distortion caused by objects for augmented reality. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

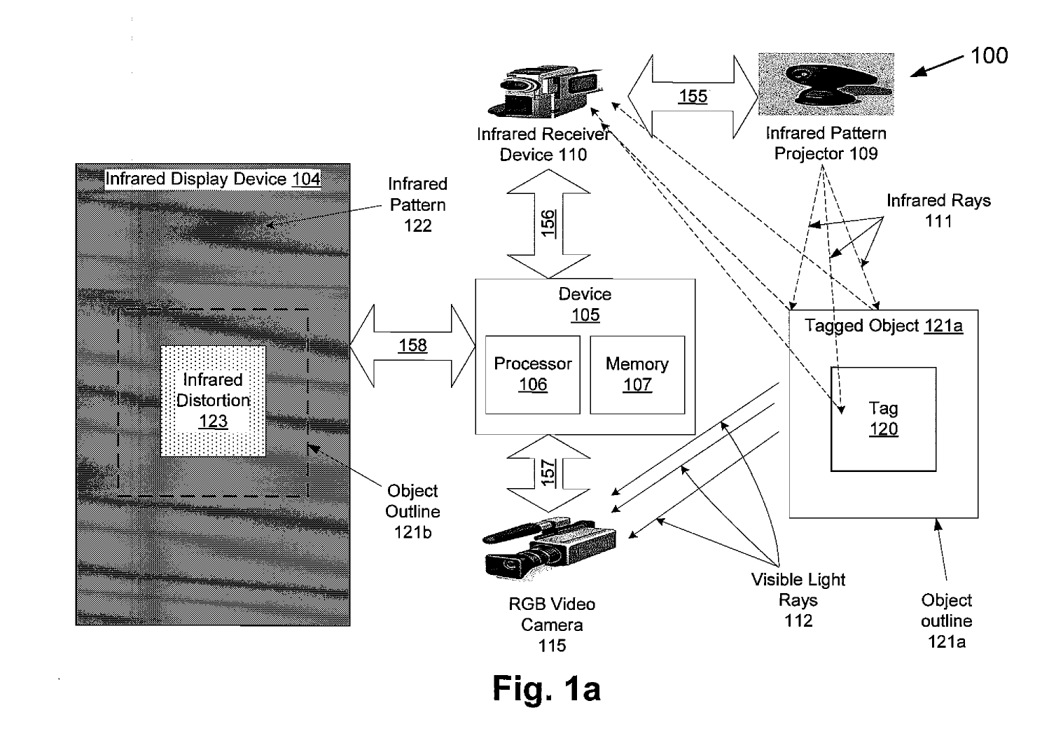

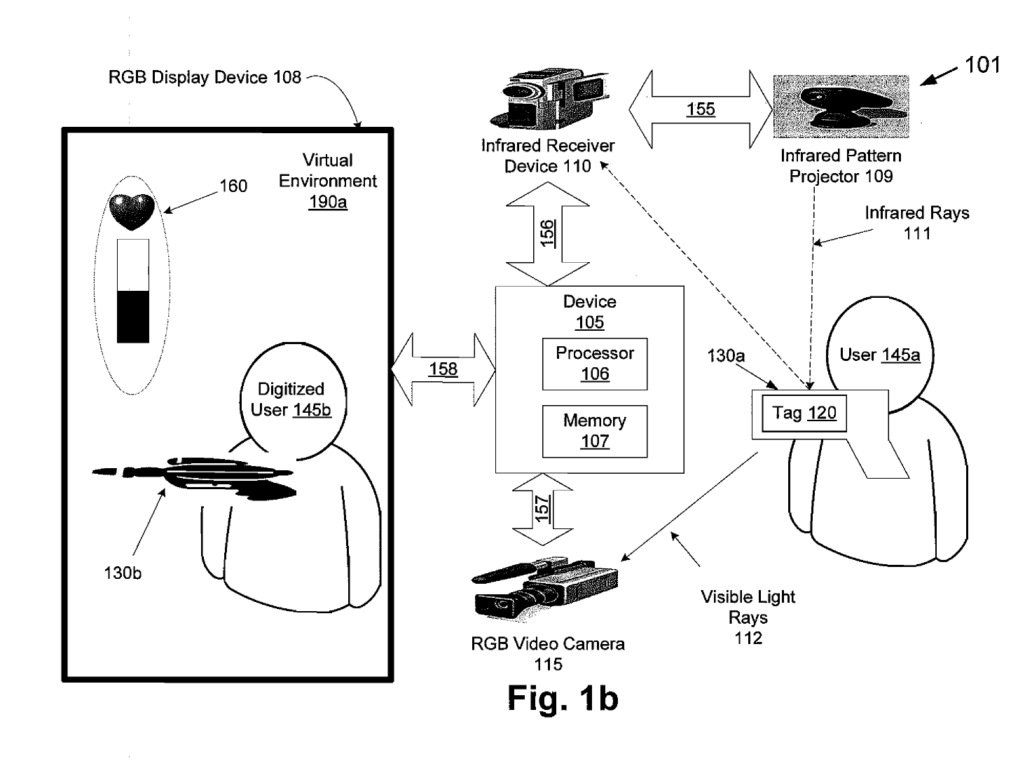

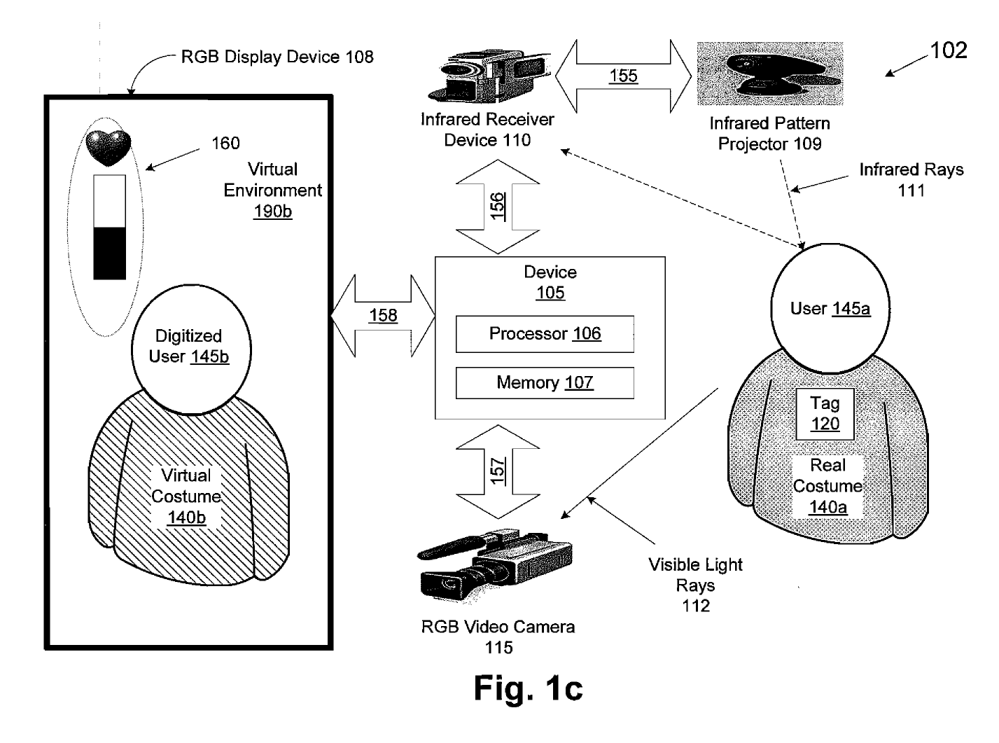

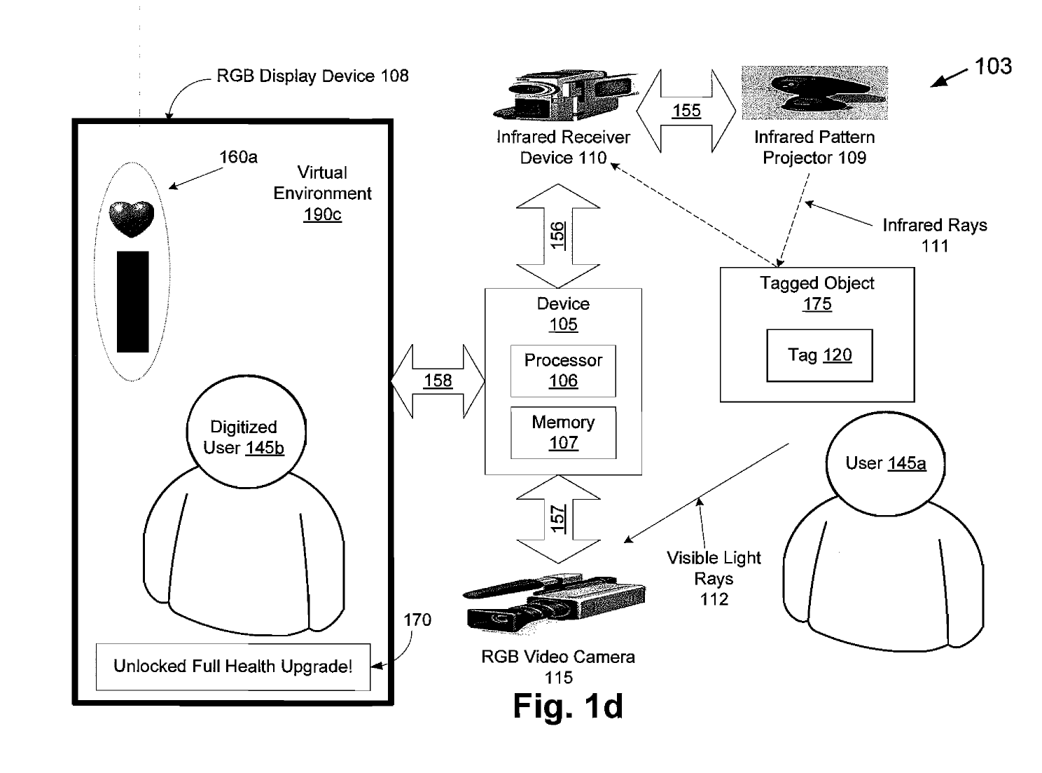

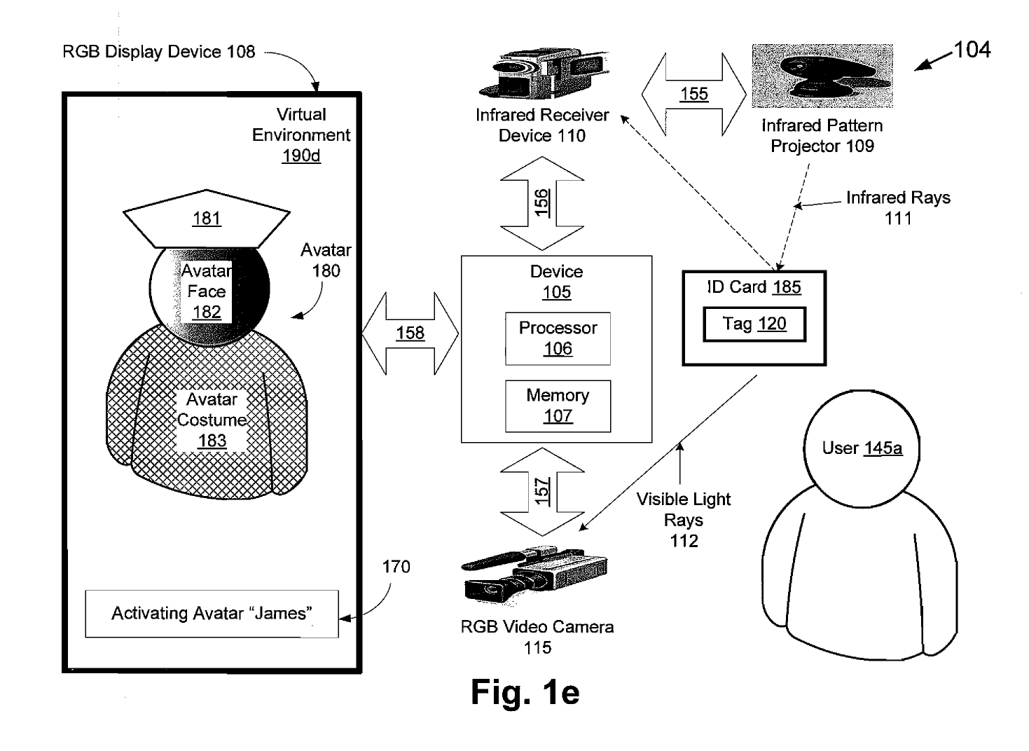

FIG. 1a presents a diagram of a system for tracking an object with an infrared distortion tag, according to one embodiment of the invention. Diagram 100 of FIG. 1a includes infrared pattern projector 109, infrared receiver device 110, infrared rays 111, visible light rays 112, device 105, tagged object 121a, object outline 121b, infrared display device 104, RGB video camera 115, and data links 155, 156, 157 and 158. Infrared display device 104 may show infrared pattern 122, infrared distortion 123 and object outline 121b. Device 105 includes processor 106 and memory 107. The surface of tagged object 121a includes tag 120.

Infrared receiver device 110, which may comprise an infrared camera, may instruct infrared pattern projector 109 through data link 155 to project infrared rays 111 as a uniformly patterned grid onto a physical environment. Infrared rays 111 may also be projected as a series of dots or as another pattern. Infrared receiver device 110 may be implemented as a standard CMOS camera with an infrared filter. Furthermore, in some embodiments, infrared receiver device 110 and may be combined with RGB video camera 115. Infrared pattern projector 109 may, for example, comprise a plurality of infrared LEDs and a pattern filter. In alternative embodiments of the invention, infrared pattern projector 109 may emit infrared rays 111 in a non-uniform fashion.

In one embodiment of the invention, infrared receiver device 110 and infrared pattern projector 109 may comprise separate devices, with data link 155 comprising a wired or wireless data connection. In alternative embodiments, infrared receiver device 110 and infrared pattern projector 109 may be combined into a single combination transmitter and receiver device with an internal data link 155.

In conventional tracking systems, it is known to use infrared receiver device 110, infrared pattern projector 109, and RGB video camera 115 to track objects with depth perception and to determine object outlines. However, conventional tracking systems do not use infrared distortion tags, such as tag 120 placed on tagged object 121a. This additional element allows objects to be tracked more easily and accurately.

For example, as shown in FIG. 1a, infrared rays 111 are projected onto a physical environment, which may include objects such as tagged object 121a. Infrared receiver device 110 may then receive infrared rays 111 that are reflected, absorbed, or otherwise affected by the presence of tagged object 121a, thereby providing additional data to enable the calculation of depth, shape, and positional information for tagged object 121a.

Additionally, infrared receiver device 110 may more easily identify tagged object 121a by detecting distortions to infrared rays 111 caused by tag 120. Tag 120 may comprise a flat adhesive tag that is attached to a surface of tagged object 121a and may comprise a pattern of infrared reactive materials. For example, tag 120 may include a pattern of infrared absorbing dyes and/or a pattern of infrared retro-reflective surfaces. The infrared absorbing dyes may comprise infrared or near-infrared absorbing dyes that may partially or completely absorb infrared rays 111. The infrared retro-reflective surfaces may comprise a surface that completely reflects infrared rays 111, or may alternatively alter the wavelength of infrared rays 111 to partially reflect infrared rays 111. In some embodiments, tag 120 may comprise a square shaped tag, such as a 3-inch square. If the size of tag 120 is known in advance, then the size of infrared distortions caused by tag 120 as captured by infrared receiver device 110 may also be utilized for more precise depth calculation of tagged object 121a. However, in alternative embodiments, tag 120 may comprise any shape and size. Additionally, although infrared wavelengths are utilized by the present examples, alternative embodiments may use any suitable non-visible wavelength. In some embodiments, tag 120 may be a part or portion of the object or the entire object, and in other embodiments, tag 120 may be a separate item that is attachable to another object.

Accordingly, infrared distortion tags such as tag 120 may generate uniquely recognizable infrared distortion patterns that can identify attached objects, such as tagged object 121a. By combining this information with a standard visible light capture of the physical environment using RGB video camera 115, the specific position of tagged object 121a may be easily recognized and tracked, even if tagged object 121a is moving or even if infrared receiver device 110 is moving.

This concept is illustrated schematically by infrared display device 104, which may display a video feed received from infrared receiver device 110. Infrared distortion 123 corresponds to the infrared distortions caused by tag 120. For example, tag 120 may interact with infrared rays 111 such that fewer infrared rays 111 are reflected to infrared receiver device 110. Additionally, tag 120 may generate a specific distortion pattern, such as a symbol, letter, barcode, or other distinctive shape, so that infrared distortion 123 can uniquely identify an associated object, such as tagged object 121a. Object outline 121b indicates the general position of tagged object 121a, and may be identified by changes in infrared pattern 122. RGB video camera 115 may receive visible light rays 112 to create a standard image of the physical environment, including tagged object 121a. The standard image may be transmitted to device 105 through data link 157. Device 105 may comprise a personal computer, a handheld device such as a smartphone or mobile gaming device, or another device including a processor 106 and a memory 107. Additionally, in some embodiments, infrared receiver device 110, RGB video camera 115, and infrared pattern projector 109 may be integrated within device 105.

Thus, after receiving image data from infrared receiver device 110 and RGB video camera 115, memory 107 of device 105 may include an infrared image, which is shown on infrared display device 104, and a standard image. Processor 106 may further map tagged object 121a into a virtual environment by comparing a position of infrared distortion 123 in the infrared image to a corresponding position in the standard image. In this manner, a detailed image outline of tagged object 121a may be identified in the standard image. The detailed image outline allows tagged object 121a or the physical object in the standard image to be easily replaced or overlaid with a virtual object, thereby enabling various augmented reality applications. Since infrared distortion 123 is easily identified even if the physical environment has poor viewing conditions and even if tagged object 121a or infrared receiver device 110 are in motion, enhanced object detection and tracking is provided even in busy and visually challenging capture environments.

Additionally, infrared receiver device 110, infrared pattern projector 109, and RGB video camera 115 may be in very close proximity to each other, preferably in a manner allowing each device to receive the same or a similar field-of-view. In this manner, tracking and positioning calculations may be facilitated since compensation for different fields of view is unnecessary.

Turning now to FIG. 1b, FIG. 1b presents a diagram of a system for tracking an object with an infrared distortion tag to present virtual objects in an augmented reality environment, according to one embodiment of the present invention. Diagram 101 of FIG. 1b includes device 105, user 145a, tagged toy weapon 130a, infrared rays 111, visible light rays 112, infrared pattern projector 109, infrared receiver device 110, RGB video camera 115, device 105, RGB display device 108, virtual environment 190a, and data links 155, 156, 157 and 158. RGB display device 108 may display virtual health meter 160, digitized user 145b, and virtual weapon 130b. Tagged toy weapon 130a includes tag 120. Device 105 includes processor 106 and memory 107. With respect to FIG. 1b, elements with like numbers may correspond to similar elements in FIG. 1a.

In diagram 101 of FIG. 1b, infrared pattern projector 109 emits infrared rays 111 into a section of a physical environment surrounding infrared pattern projector 109. The physical environment includes user 145a and tagged toy weapon 130a. Some portions of infrared rays 111 may contact tagged toy weapon 130a, including tag 120. Other portions of infrared rays 111 may strike the surface of user 145a. As described above, tag 120 may have a surface comprising a pattern of infrared absorbing dyes and infrared retro-reflective surfaces. The distortions in the grid of infrared rays 111 as a result of tag 120 are captured by infrared receiver device 110.

Processor 106 of device 105 receives infrared image data from infrared receiver device 110 and standard image data from RGB video camera 115, and may execute a software application in memory 107 to render a virtual environment 190 outputting to RGB display device 108. RGB display device 108 may be any display device, such as a liquid crystal display (LCD) device. In one embodiment, RGB display device 108 may comprise a LCD display screen with touch sensitive capabilities.

As discussed above, device 105 may utilize processor 106 to detect an infrared grid distortion caused by tag 120, similar to infrared distortion 123 of FIG. 1a. By comparing the location of the distortion in the infrared image with the standard image, processor 106 can more precisely calculate the location of tagged toy weapon 130a in the standard image. Processor 106 may also query tag 120 using a database of virtual objects and determine that based on the unique pattern of tag 120, virtual weapon 130b should replace tagged toy weapon 130a in virtual environment 190a. Thus, when device 105 renders virtual environment 190a on RGB display device 108, tagged toy weapon 130a is replaced with virtual weapon 130b and user 145a is converted into digitized user 145b. Digitized user 145b may be extracted from a standard image received from RGB video camera 115.

Virtual environment 190a may comprise a virtual reality environment, an augmented reality video game, a social networking space, or any other interactive environment. For augmented reality, a portion of the standard image captured by RGB video camera 115 may be transferred directly into virtual environment 190b. This portion may include, for example, digitized user 145b received from the standard image of RGB video camera 115. Virtual health meter 160 may be a graphical image superimposed onto virtual environment 190a. Virtual health meter 160 may indicate the health level of digitized user 145b as digitized user 145b interacts with an augmented reality videogame of virtual environment 190a.

As tagged toy weapon 130a moves within the physical environment, tag 120 also moves along with it, moving the position of the infrared grid distortion caused by tag 120. Accordingly, device 105 may smoothly track the motion of tagged toy weapon 130a by tracking the movement of the infrared grid distortion using infrared receiver device 110. Thus, user 145a and/or other spectators can observe RGB display device 108 where user 145a appears to be holding a virtual weapon 130b rather than tagged toy weapon 130a. Moreover, user 145a may move freely in the physical environment and device 105 can still track the movement of tagged toy weapon 130a by tracking the infrared distortion caused by tag 120. Accordingly, device 105 can convincingly render virtual environment 190a on RGB display device 108 such that virtual weapon 130b appears to replace tagged toy weapon 130a and track its movements.

Moving to FIG. 1c, FIG. 1c presents a diagram of a system for tracking an object with an infrared distortion tag to present virtual costumes in an augmented reality environment, according to one embodiment of the present invention. Diagram 102 of FIG. 1c includes user 145a, infrared rays 111, visible light rays 112, infrared pattern projector 109, infrared receiver device 110, device 105, RGB video camera 115, RGB display device 108, virtual environment 190b, and data links 155, 156, 157 and 158. Virtual environment 190b may include virtual health meter 160, digitized user 145b, and virtual costume 140b. User 145a may be wearing real costume 140a with tag 120 attached. Device 105 may include processor 106 and memory 107. With respect to FIG. 1c, elements with like numbers may correspond to similar elements in FIG. 1b.

FIG. 1c illustrates an augmented reality example similar to FIG. 1b. However, rather than replacing a tagged toy weapon 130a with a virtual weapon 130b as in FIG. 1b, a real costume 140a is replaced with a virtual costume 140b in FIG. 1c. Thus, for example, user 145a can observe himself on RGB display device 108 wearing a futuristic suit, or virtual costume 140b, instead of a plain t-shirt, or real costume 140a.

Turning to FIG. 1d, FIG. 1d presents a diagram of a system for recognizing an object with an infrared distortion tag to unlock special features of an augmented reality videogame, according to one embodiment of the present invention. Diagram 103 of FIG. 1d includes tagged object 175, user 145a, infrared rays 111, visible light rays 112, infrared pattern projector 109, infrared receiver device 110, RGB video camera 115, device 105, RGB display device 108, virtual environment 190c, and data links 155, 156, 157 and 158. Virtual environment 190c may include virtual health meter 160a, digitized user 145b, and full health upgrade unlocked text message 170. Device 105 includes processor 106 and memory 107. With respect to FIG. 1d, elements with like numbers may correspond to similar elements in FIG. 1c.

FIG. 1d illustrates an augmented reality example similar to FIG. 1c. However, rather than replacing a real costume 140a with a virtual costume 140b as in FIG. 1c, a tagged object 175 is detected in FIG. 1d that unlocks a special feature of virtual environment 190c. For example, tagged object 175 may represent a full health upgrade item. Thus, for example, if device 105 comprises a portable video game system with an integrated infrared receiver device 110, then user 145a only needs to orient infrared receiver device 110 towards tagged object 175 to activate the full health upgrade item. Device 105 may then process the infrared image received from infrared receiver device 110 to identify and recognize tag 120 as a full health upgrade item. Accordingly, virtual health meter 160a may be replenished with full health, and a text message 170 may appear superimposed onto virtual environment 190c. In alternative embodiments, other special effects or features may be unlocked in virtual environment 190c.

Proceeding to FIG. 1e, FIG. 1e presents a diagram of a system for authenticating an object with an infrared distortion tag to unlock a custom avatar of an augmented reality videogame, according to one embodiment of the present invention. Diagram 104 of FIG. 1e includes infrared pattern projector 109, infrared rays 111, user 145a, visible light rays 112, infrared receiver device 110, RGB video camera 115, device 105, RGB display device 108, ID card 185, tag 120, virtual environment 190d, and data links 155, 156, 157 and 158. RGB display device 108 may display avatar 180. Avatar 180 may include avatar hat 181, avatar face 182, and avatar costume 183. RGB display device 108 may also include avatar activation message 170. Device 105 includes processor 106 and memory 107.

FIG. 1e illustrates an augmented reality example similar to FIG. 1d. However, rather than detecting a tagged object 175 to unlock a special feature of virtual environment 190c as in FIG. 1d, an ID card 185 is detected to authenticate and unlock a customized avatar, or avatar 180, in virtual environment 190d. Virtual environment 190d may comprise a virtual reality video game where all graphics are rendered without using any graphics from the standard image received from RGB video camera 115. Thus, besides augmented reality applications as illustrated in FIGS. 1b, 1c, and 1d, the object tracking system with infrared tag distortion tags may also be used for conventional motion controlled gaming applications, as illustrated in FIG. 1e.

Avatar 180 may be a graphical character representation of user 145a in virtual environment 190d. For example, user 145a may have previously created, customized, and recorded avatar 180 within device 105. Avatar 180 includes avatar hat 181, avatar face 182, and avatar costume 183, which user 145a may have personally customized and programmed into device 105. Then, user 145a may associate avatar 180 with ID card 185, for example by directing infrared receiver device 110 towards ID card 185 during an avatar registration procedure. At a later time when user 145a wants to use avatar 180, user 145a may again point infrared receiver device 110 towards ID card 185 during a login procedure. Tag 120, which is attached to ID card 185, may be detected using the infrared grid distortion technique as previously described, and device 105 may identify ID card 185 as being associated with avatar 180. Since tag 120 may be made difficult to duplicate, for example by using a complex infrared pattern, it may also serve as an authentication token to prove the identity of the user carrying ID card 185. Further, tag 120 may be made even more difficult to duplicate or reproduce due to having special materials and dyes for IR reflection and absorption, which cannot be printed using a household printer or copied using a copier. Also, advantageously, objects with the same color scheme will not be confused when performing vision recognition, e.g. a small plastic Donald figure zoomed in looks very similar to a huge Donald plush toy zoomed out, and objects with the same outline will not be confused using an IR depth camera, e.g. most medium size ten-year old girls look the same.

Thus, device 105 may authenticate ID card 185 and render avatar 180 in virtual environment 190d rendered on RGB display device 108, and may also show avatar activation message 170, which may comprise a text box overlay.

Besides directly affecting rendered overlays for augmented reality, the object recognition, authentication, and tracking system may also be used for other effects and use cases. For example, rather than loading a custom avatar, ID card 185 of FIG. 1e may instead be utilized to unlock and start a video game. In other embodiments, a tagged object may be utilized to move a cursor in a user interface or to directly control an on screen avatar. For example, ID card 185 might be placed on a special game board, and movement of ID card 185 may correspondingly translate to movement of avatar 180. Thus, the tracking system may be broadly applicable to various use cases and is not restricted to only augmented reality use cases.

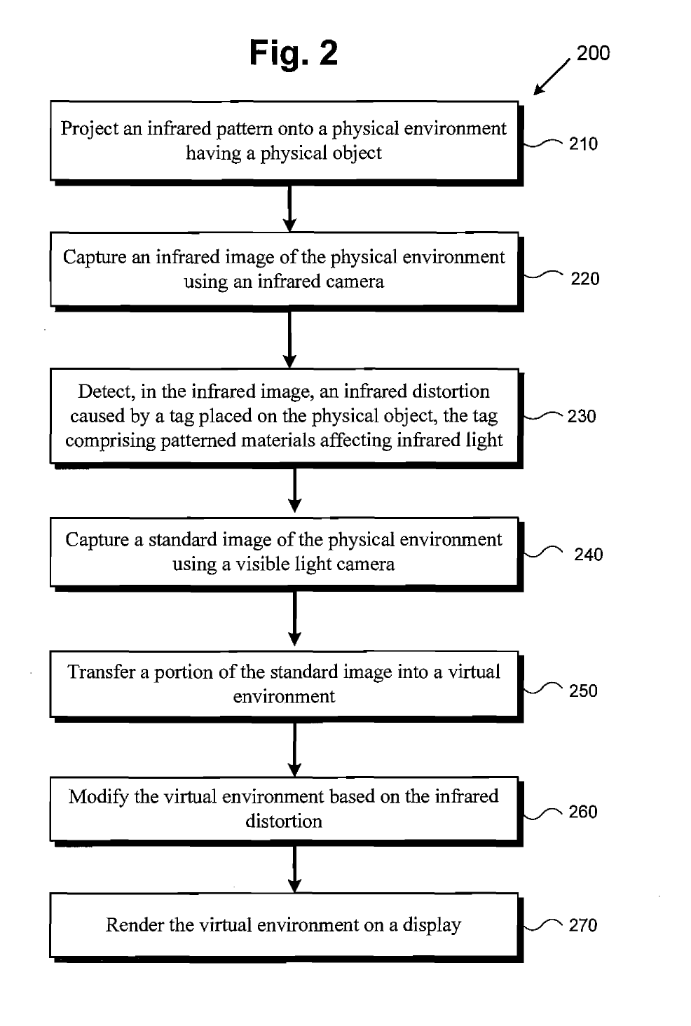

The systems shown in FIGS. 1a, 1b, 1c, and 1d will now be further described by additional reference to FIG. 2. FIG. 2 shows flowchart 200 describing the steps, according to one embodiment, by which an object may be recognized, authenticated, and tracked with an infrared distortion tag. Certain details and features have been left out of flowchart 200 that re apparent to a person of ordinary skill in the art. Thus, a step may comprise one or more substeps or may involve specialized equipment or materials, for example, as known in the art. While steps 210 through 270 indicated in flowchart 200 are sufficient to describe one embodiment of the preset method, other embodiments may utilize steps different form those shown in flowchart 200, or may include more, or fewer steps.

Referring to step 210 of flowchart 200 and FIG. 1a and FIG. 1b, step 210 comprises projecting an infrared pattern onto a physical environment having a physical object. Projecting an infrared pattern onto a physical environment may be performed by infrared pattern projector 109 at the direction of infrared receiver device 110, which may operate independently or further under the direction of device 105. In one embodiment of the invention, infrared rays 111 are uniformly emitted and form an infrared grid. The uniformly projected infrared rays 111 are focused upon a section of the physical environment. This section may also be known as sensory field-of-view of infrared pattern projector 109.

The method of flowchart 200 continues with step 220, which comprises capturing an infrared image of the physical environment using an infrared camera. Step 220 may be performed using infrared receiver device 110 functioning as the infrared camera to receive reflected infrared rays 111 as raw camera data. Infrared receiver device 110 may then use the raw camera data to create an infrared image of the field-of-view within the physical environment. The infrared image may then be transmitted to device 105. In alternative embodiments of the invention, device 105 may instead process the raw camera data into the infrared image. Additionally, as previously described, infrared receiver device 110 may be integrated with infrared pattern projector 109, and both may be integrated within device 105. Furthermore, alternative non-visible wavelengths may be utilized instead of infrared wavelengths.

Moving on to step 230 of flowchart 200, step 230 comprises detecting, in the infrared image, an infrared distortion 123 caused by a tag 120 placed on the physical object, the tag 120 comprising patterned materials affecting infrared light. Device 105, using data transmitted from infrared receiver device 110, may detect for infrared distortion 123. Infrared distortion 123 may be created when infrared rays 111 strike tag 120 and are reflected back to infrared receiver device 110, or are absorbed into tag 120. Tag 120 may comprise a surface of infrared distorting patterns based on a combination of infrared absorbing dyes and infrared retro-reflective surfaces. Device 105 may analyze infrared pattern 122, detect infrared distortion 123, and match infrared distortion 123 to a database of distinctive distortion patterns to uniquely identify tag 120 and the associated physical object that tag 120 is attached to.

Step 240 of flowchart 200 comprises capturing a standard image of the physical environment using a visible light camera. A visible light camera, such as RGB video camera 115, may capture visible light rays 112 and digitize the physical environment into a standard image. As previously described, RGB video camera 115, infrared receiver device 110, and infrared pattern projector 109 may be placed close together so that each device have the same or similar fields of view. Mirrors, filters, or other apparatuses may also be utilized to align the fields of view. Alternatively, as previously described, RGB video camera 115 and infrared receiver device 110 may use the same camera hardware with an infrared filter to provide the infrared image.

Referring to step 250 of flowchart 200, step 250 comprises transferring a portion of the standard image into virtual environment 190a. Thus, a portion of the standard image captured by RGB video camera 115 may be transmitted to RGB display device 108. This portion may include, for example, digitized user 145b, which corresponds to a digitized capture of user 145a. Virtual environment 190a may comprise an augmented reality video game, where portions of virtual environment 190a may correspond to the standard image and other portions may be overlaid with virtual objects, such as virtual weapon 130b. However, in alternative embodiments wherein virtual environment 190a is fully rendered without using any data from the standard image, step 250 may be skipped.

Continuing with step 260 of flowchart 200, step 260 comprises modifying the virtual environment 190a based on the infrared distortion 123 detected from step 230. Infrared distortion 123 is caused by tag 120. The distinctive distortion pattern of infrared distortion 123 may be recognized and associated with an object tag 120 is attached to, such as tagged toy weapon 130a. Device 105 may then overlay a virtual object, such as virtual weapon 130b, over the associated real object, or tagged toy weapon 130a. Besides object tracking to overlay a virtual object on top of a real one as in FIG. 1b, the modifying of the virtual environment may also include object tracking to overlay a virtual costume over a real costume as in FIG. 1c, object recognition to unlock a special feature as in FIG. 1d, and option authentication to unlock a customized avatar as in FIG. 1e.

Referring to step 270 of flowchart 200, step 270 comprises rendering virtual environment 190a on a display device. The virtual environment 190a created in step 260 may be rendered onto a display device, such as RGB display device 108. RGB display device 108 may display digitized user 145b, virtual weapon 130b and virtual health meter 160, thus providing an augmented reality in virtual environment 190a wherein user 145a is holding a virtual weapon 130b instead of a tagged toy weapon 130a. However, besides augmented reality overlays, the object recognition, authentication, and tracking method shown in flowchart 200 may also be utilized for other use cases such as game unlocking, user interface control, and avatar movement, as previously described.

Thus, a method for recognizing, authenticating, and tracking an object using infrared distortion tags for augmented reality applications has been described. Rather than conventionally detecting the surfaces and contours of objects, which is prone to measurement error and has a limited range of detection, the use of infrared distortion tags provides an easy way to accurately track objects, including objects in movement and objects that may be difficult to observe using visible light captures alone. By corroborating the detected distortion position with standard image data obtained from RGB video camera 115, the tracking system may accurately pinpoint the location of an associated object, such as tagged toy weapon 130a, allowing clean and convincing replacement with virtual objects for augmented reality applications. Besides object replacement in a virtual environment, the specific pattern detected from the infrared distortion tag can also be programmed to affect a virtual environment in certain ways, such as costume replacement, feature unlocking, enabling custom avatars, and more.

Since infrared distortion is tracked rather than changes in the visible scene, device 105 can easily recognize an object even if the object is partially concealed or placed in an environment having a background pattern similar to a surface of the object. Visually similar or identical objects may also be easily differentiated with tags having unique infrared distortion patterns. Furthermore, since tag 120 may be designed as a small and unobtrusive addition, tag 120 may be discreetly applied to objects to avoid undesirable changes in appearance. Additionally, tag 120 may serve an authentication function, since the pattern of tag 120 may be made difficult to duplicate or copy. Thus, tag 120 may provide protection against fake or counterfeit items.

Furthermore, tag 120 may be tracked at longer distances since infrared distortion 123 may be recognized at longer distances compared to using only standard cameras. At closer distances, the disclosed infrared tracking system may also detect the presence of objects with greater ease since only the infrared distortion needs to be detected. Thus, the disclosed tracking system provides greater tracking accuracy compared to conventional tracking systems while using commodity hardware for low cost deployment, enabling more exciting and more convincing augmented reality applications with relevance to video games, entertainment, and other fields.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangement, modifications, and substitutions without departing from the scope of the invention.

What is claimed is:

1. A method for virtual environment manipulation by detection of physical objects, the method comprising:
projecting an infrared pattern onto a physical environment having a physical object;
capturing an infrared image of the physical environment using an infrared camera;
detecting, in the infrared image, an infrared distortion caused by at least a portion of the physical object, the at least portion of the physical object comprising patterned materials affecting an infrared light;
modifying a virtual environment based on the infrared distortion caused by the patterned materials affecting the infrared light; and
rendering the modified virtual environment on a display.

2. The method of claim 1, wherein the at least portion of the physical object is a tag placed on the physical object.

3. The method of claim 1 further comprising, prior to said modifying:
capturing a standard image of the physical environment using a visible light camera; and
transferring a portion of the standard image into the virtual environment.

4. The method of claim 1, wherein the modifying comprises:
mapping a location of the physical object in the standard image by comparing a position of the infrared distortion in the infrared image;
replacing the physical object with a virtual object in the virtual environment by using the location of the physical object.

5. The method of claim 4, wherein the physical object comprises a toy weapon, and wherein the virtual object comprises a virtual weapon.

6. The method of claim 4, wherein the physical object comprises a real costume, and wherein the virtual object comprises a virtual costume.

7. The method of claim 1, wherein the modifying comprises unlocking a special feature of the virtual environment.

8. The method of claim 1, wherein the portion of the standard image includes a digitized user corresponding to the user in the physical environment.

9. The method of claim 1, wherein the modifying comprises unlocking a custom avatar in the virtual environment.

10. The method of claim 1, wherein the at least portion of the physical object includes a pattern of infrared absorption dyes or infrared retro-reflective surfaces.

11. A system for providing virtual environment manipulation by detection of physical objects, the system comprising:
a physical object in a physical environment, wherein at least a portion of the physical objected comprising patterned materials affecting an infrared light;
an infrared pattern projector;
an infrared camera;
a visible light camera;
a display;
a processor configured to:
project an infrared pattern onto the physical environment;
capture an infrared image of the physical environment using the infrared camera;
detect, in the infrared image, an infrared distortion caused by the tag;
modify a virtual environment based on the infrared distortion caused by the patterned materials affecting the infrared light; and
render the modified virtual environment on the display.

12. The system of claim 11, wherein the at least portion of the physical object is a tag placed on the physical object.

13. The system of claim 11, wherein prior to the modifying, the processor is further configured to:
capture a standard image of the physical environment using the visible light camera; and
transfer a portion of the standard image into the virtual environment.

14. The system of claim 11, wherein the modifying of the virtual environment is by the processor further configured to:
map a location of the physical object in the standard image by comparing a position of the infrared distortion in the infrared image;
replace the physical object with a virtual object in the virtual environment by using the location of the physical object.

15. The system of claim 14, wherein the physical object comprises a toy weapon, and wherein the virtual object comprises a virtual weapon.

16. The system of claim 14, wherein the physical object comprises a real costume, and wherein the virtual object comprises a virtual costume.

17. The system of claim 11, wherein the modifying comprises unlocking a special feature of the virtual environment.

18. The system of claim 11, wherein the portion of the standard image includes a digitized user corresponding to the user in the physical environment.

19. The system of claim 11, wherein the modifying comprises unlocking a custom avatar in the virtual environment.

20. The system of claim 11, wherein the at least portion of the physical includes a pattern of infrared absorption dyes or infrared retro-reflective surfaces.
